(19) United States
(12) Patent Application Publication
(10) Pub. No.: US 2019/0201887 A1
(43) Pub. Date: Jul. 4, 2019

(54) DOOR APPARATUS AND GLOVE BOX

(71) Applicant: AP SYSTEMS INC., Hwaseong-Si (KR)

(72) Inventors: Jae Keun HYUN, Cheonan-Si (KR); Hee Woon LEE, Seoul (KR); Yong Seok KIM, Hwaseong-Si (KR)

(21) Appl. No.: 15/859,266

(22) Filed: Dec. 29, 2017

(51) Int. Cl. B01L 1/02; E05C 19/16; E05F 5/02

(52) U.S. Cl. CPC B01L 1/025; E05C 19/166; E05D 3/08; E05Y 2201/212; E05Y 2900/21; E05F 5/02

(57) ABSTRACT

Provided is a door apparatus that is installed on a chamber including an inner space and an opening defined in one surface thereof. The door includes a cover unit configured to cover the opening, a first magnetic unit installed on the cover unit or the chamber, and a second magnetic unit installed on the cover unit or the chamber to face the first magnetic unit, converting a polarity thereof, and coupled to the first magnetic unit in a separable manner

### BACKGROUND

The present disclosure relates to a door apparatus and a glove box, and more particularly, to a door apparatus, which may be easily opened and closed and stably seal an inside of a chamber, and a glove box.

In general, a glove box has an inner empty space and an opening defined in one surface thereof. Also, a door defined along a shape of the opening is installed on the glove box to open and close the opening. For example, when the glove box is filled with a N₂ gas, the glove box may be sealed by using the door in order to prevent external air from being introduced into the glove box or the N₂ gas in the glove box from being leaked to the outside.

Conventionally, the door is compressed to the box by using a clamping unit. That is, the door is disposed on the opening of the glove box, and the door is pressed toward the box by a plurality of clamping units. Accordingly, the opening of the box is covered by the door, and a gap between the box and the door is removed, so that an inside of the box is sealed.

However, approximately one hundred of clamping units are necessary to remove the gap by compressing the door to the box. Even when a small-sized door is compressed, approximately forty to approximately fifty clamping units are demanded. Accordingly, when at least some of the plurality of clamping units are not normally operated, the gap between the door and the box may be generated. Also, since all of the plurality of clamping units are operated to open the door, it requires a lot of time to open and close the door. Also, whenever the door is opened and closed, since the clamping units apply an impact, the door may be easily damaged.

### RELATED ART DOCUMENT

### Patent document

(Patent document 1) Korean Patent Publication No. 10-2011-0127586

### SUMMARY

The present disclosure provides: a door apparatus capable of being easily opened and closed and stably sealing an inside of a chamber; and a glove box.

The present disclosure also provides a door apparatus and a glove box, which allow a maintenance work for equipment disposed therein to be easily performed.

In accordance with an exemplary embodiment, a door apparatus that is installed on a chamber including an inner space and an opening defined in one surface thereof, the door includes: a cover unit configured to cover the opening; a first magnetic unit installed on the cover unit or the chamber; and a second magnetic unit installed on the cover unit or the chamber to face the first magnetic unit, converting a polarity thereof, and coupled to the first magnetic unit in a separable manner

In an exemplary embodiment, the first magnetic unit may be fixed, and the second magnetic unit may be converted in position of a polarity.

In an exemplary embodiment, the second magnetic unit may include a support member installed on the chamber or the cover unit and a magnet member installed in the support member in a rotatable manner

In an exemplary embodiment, the second magnetic unit may include an electromagnet and a power supply unit configured to supply a current to the electromagnet.

In an exemplary embodiment, the door apparatus may further include: a position detecting unit configured to detect a position of the cover unit; and a control unit connected to the position detecting unit and control an operation of the power supply unit.

In an exemplary embodiment, the first magnetic unit may include at least one of a metal member and a magnet.

In an exemplary embodiment, the door apparatus may further include a buffer unit installed on at least one of the first magnetic unit and the second magnetic unit in order to reduce an impact between the first magnetic unit and the second magnetic unit.

In an exemplary embodiment, the chamber may include a first projection configured to surround a circumference of the opening and a second projection configured to surround a circumference of the first projection, and the cover unit may include a first cover configured to cover the opening and a second cover connected to the first cover to cover a gap between the first cover and the first projection and contacting the second projection.

In an exemplary embodiment, the door apparatus may further include a sealing unit installed on the cover unit in order to block a gap between the chamber and the cover unit and contacting the chamber.

In an exemplary embodiment, the sealing unit may include at least one of a first sealing member installed on the first cover and a second sealing member installed on the second cover.

In accordance with another exemplary embodiment, a glove box includes: a chamber having an inner space and an opening defined in one surface thereof; a gas supply unit configured to supply an inert gas into the chamber; and a door configured to open and close the opening by a magnetic force.

In an exemplary embodiment, the door may include: a cover unit configured to cover the opening; a first magnetic unit installed on the cover unit or the chamber; and a second magnetic unit installed on the chamber or the cover unit to face the first magnetic unit and converting a polarity of a portion facing the first magnetic unit.

In an exemplary embodiment, the first magnetic unit and the second magnetic unit may be provided in plurality and arranged along a circumference of the opening.

In an exemplary embodiment, the door may further include a sealing unit installed on the cover unit so as to contact the chamber and arranged at least one position of an inside and an outside of a circumference of each of the first magnetic unit and the second magnetic unit along the circumference of the opening.

In an exemplary embodiment, the sealing unit may have at least one portion protruding the outside of the cover unit, and the door may further include a pressing unit configured to allow the sealing unit to closely contact the chamber.

In an exemplary embodiment, the pressing unit may include a first magnetic body installed on the cover unit and a second magnetic body installed on the chamber, and the sealing unit is disposed between the first magnetic body and the second magnetic body.

In an exemplary embodiment, the glove box may further include: an oxygen measuring unit configured to measure an oxygen concentration in the chamber; and a control unit configured to convert a polarity of the second magnetic unit on the basis of a measurement result obtained by the oxygen measuring unit.

In an exemplary embodiment, the glove box may further include an oxygen supply unit configured to supply a gas containing oxygen into the chamber.

In an exemplary embodiment, the glove box may further include: an inlet-outlet port defined in the chamber; a gate configured to open and close the inlet-outlet port; and a transfer unit installed in the chamber to transfer a substrate through the inlet-outlet port.

### BRIEF DESCRIPTION OF THE DRAWINGS

Exemplary embodiments can be understood in more detail from the following description taken in conjunction with the accompanying drawings, in which:

FIG. 1 is a conceptual perspective view illustrating an appearance of a glove box in accordance with an exemplary embodiment;

FIG. 2 is a conceptual cross-sectional view illustrating an appearance of a glove box in accordance with an exemplary embodiment;

FIG. 3 is a view illustrating an operational structure of a first magnetic unit and a second magnetic unit in accordance with an exemplary embodiment;

FIG. 4 is a view illustrating a structure of a door apparatus in accordance with an exemplary embodiment;

FIG. 5 is a view illustrating an operational structure of a pressing unit in accordance with an exemplary embodiment;

FIG. 6 is a view illustrating a structure of a door apparatus in accordance with another exemplary embodiment;

FIG. 7 is a view illustrating a structure of a glove box in accordance with an exemplary embodiment; and

FIG. 8 is a plan view illustrating a structure of a glove box in accordance with an exemplary embodiment.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that the present invention will be thorough and complete, and will fully convey the scope of the present invention to those skilled in the art. In the drawings, the thicknesses of layers and regions are exaggerated for clarity. Like reference numerals in the drawings denote like elements.

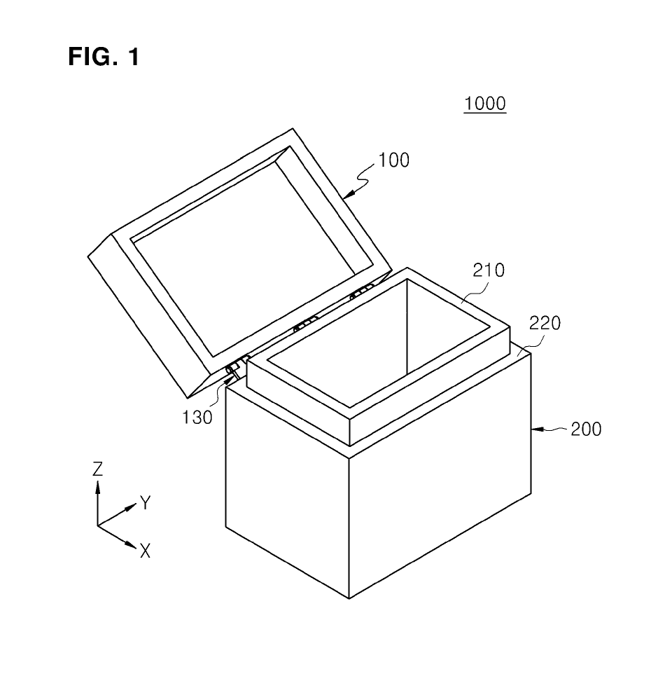

FIG. 1 is a conceptual perspective view illustrating an appearance of a glove box in accordance with an exemplary embodiment. Hereinafter, the glove box in accordance with an exemplary embodiment will be described.

Referring to FIG. 1, a glove box 1000 includes a chamber 200, a gas supply unit, and a door. Also, the glove box 1000 may further include a gas discharge unit, an oxygen measuring unit, a control unit, and a transfer unit.

The chamber 200 may have a rectangular container shape in which an inner space is defined. At least one portion of one surface (e.g. top surface) of the chamber 200 may be opened to define an opening. The opening may have a rectangular shape according to a planar shape of the chamber 200.

Also, the chamber 200 may include a first projection 210 surrounding a circumference of the opening and a second projection 220 surrounding an outer circumference of the first projection 210. The first projection 210 and the second projection 220 may have different positions in a vertical direction, and a stepped portion may be generated due to a difference between the positions in the vertical direction. For example, the first projection 210 may be disposed higher than the second projection 220. That is, the first projection 210 and the second projection 220 may be surfaces that are different in height. Alternatively, the second projection 220 may be disposed higher than the first projection 210.

A plurality of inlet-outlet ports may be defined in a side surface of the chamber 200 so that a substrate is inserted and withdrawn therethrough. That is, the inlet-outlet ports may be defined in a surface different from the surface in which the opening is defined. The inside of the chamber 200 may be communicated with other devices for processing a substrate through the inlet-outlet ports. Here, a plurality of gates are provided on the inlet-outlet ports, respectively, to open and close each of the inlet-outlet ports. For example, the gate may be a gate valve. Accordingly, the gate may be controlled to allow the inside of the chamber 200 and insides of other devices to be communicated or blocked therebeteween. However, an exemplary embodiment is not limited to the structure and shape of the chamber 200.

A door serves to open and close the opening of the chamber 200. The door may open and close the opening of the chamber 200 by a magnetic force. Accordingly, the door may restrain or prevent a gas in the chamber 200 from being leaked to the outside or an external gas from being introduced into the chamber 200.

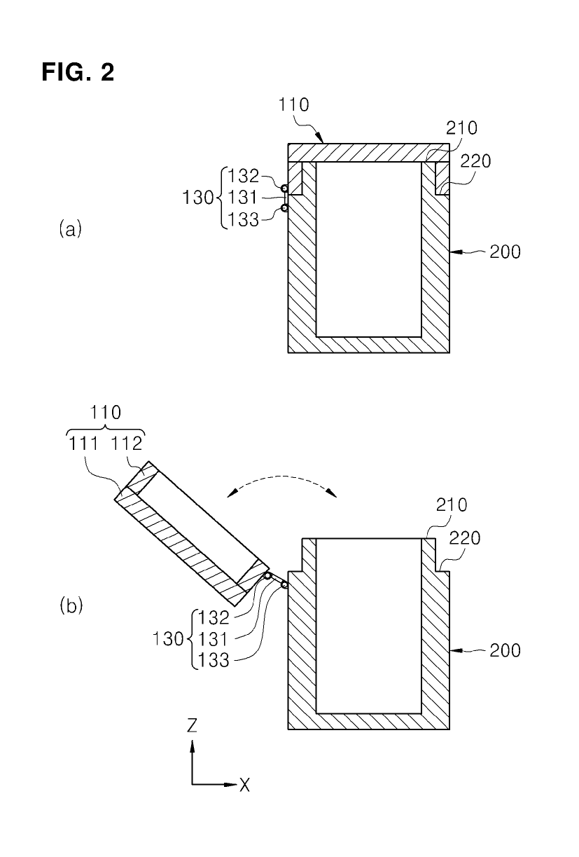

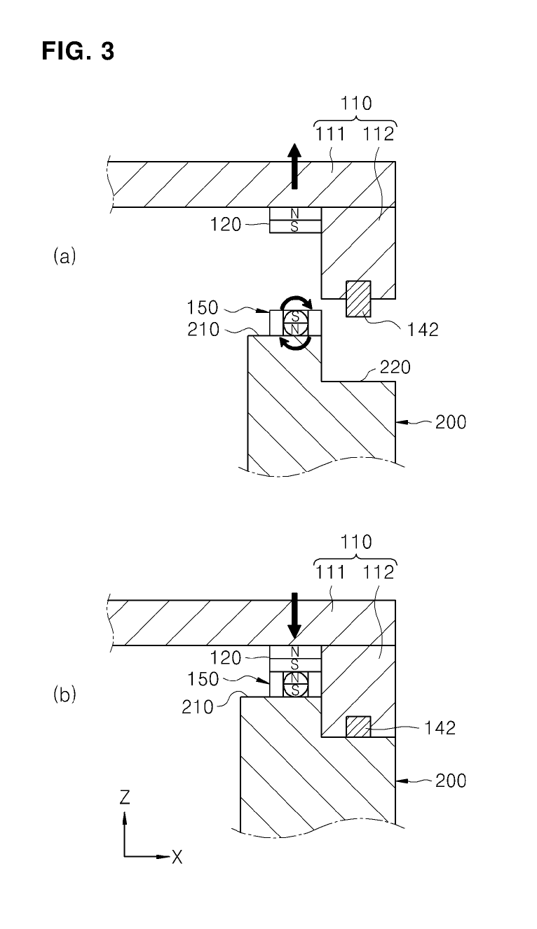

FIG. 2 is a conceptual cross-sectional view illustrating an appearance of a glove box in accordance with an exemplary embodiment, and FIG. 3 is a view illustrating an operational structure of a first magnetic unit and a second magnetic unit in accordance with an exemplary embodiment. Hereinafter, a structure of a door apparatus in accordance with an exemplary embodiment will be described in detail.

Referring to FIGS. 2 and 3, a door apparatus 100 is installed on the chamber 200 having an opening defined in one surface thereof. The door apparatus 100 includes a cover unit 110, a first magnetic unit 120, and a second magnetic unit 150. Also, the door apparatus 100 may further include a hinge unit 130, a sealing unit 140, a position detecting unit 170, and a buffer unit (not shown). Here, the door apparatus 100 may be provided on the glove box 100 in accordance with an exemplary embodiment.

The cover unit 110 serves to open and close the opening of the chamber 200. The cover unit 110 may include a first cover 111 covering the opening of the chamber 200 and a second cover 112 connected to the first cover 111 to cover a gap between the first cover 111 and the first projection 210 and capable of contacting the second projection 220.

The first cover 111 serves to cover the opening of the chamber 200. The first cover 111 may have a rectangular plate shape according to the shape of the opening of the chamber 200. The first cover 111 may have a surface area that is greater than that of the opening. Accordingly, when the first cover 111 is disposed above the opening, the first cover 111 may cover the opening so that the opening is closed. However, an exemplary embodiment is not limited to the shape of the first cover 111.

The second cover 112 serves to cover a gap between the first cover 111 and the first projection 210. The second cover 112 may have a rectangular ring shape along a circumferential shape of the first cover 111 or the first projection 210 and be connected to a lower portion of the first cover 111. That is, the second cover 112 may be connected to the first cover 111 to protrude downwards and surround a circumference of the opening.

Also, the second cover 112 may have a vertical directional length that is equal to or greater than that of the first projection 210, and a bottom surface of the second cover 112 may contact a top surface of the second projection 220. Accordingly, when the second cover 112 is seated on the second projection 220, the first cover 111 may cover the opening of the chamber 200, and the second cover 112 may cover the gap between the first cover 111 and the first projection 210. However, an exemplary embodiment is not limited to the structure and shape of the second cover 112.

Here, a handle (not shown) may be provided on the cover unit 110. For example, the handle may be installed on at least one portion among the top surface of the first cover 111, the top surface of the second cover 112, and the side surface of the second cover 112. Accordingly, a worker may open and close the cover unit 110 by using the handle.

Also, a static electricity removing member (not shown) may be provided on the cover unit 110. The static electricity removing member may be a wire made of conductive fiber. The static electricity removing member may have one end connected to at least one of the first cover 111, the second cover 112, and the handle and the other end connected to the ground. Accordingly, when the worker opens and closes the cover unit 110, static electricity may be prevented from occurring. However, an exemplary embodiment is not limited to the structure and shape of the cover unit 110.

As illustrated in FIG. 2, the hinge unit 130 serves to connect the cover unit 110 to the chamber 200 in a rotatable manner. The hinge unit 130 may include a plate 131, a first hinge 132 connecting the cover unit 110 to one side of the plate 131 in a rotatable manner, and a second hinge 133 connecting the chamber 200 to the other side of the plate 131 in a rotatable manner

The plate 131 may have a rectangular plate shape and include protruding portions on top and bottom sides thereof. The plate 131 may be provided in singularity or plurality. The plate 131 may extend in an extension direction of the first cover 111 or a direction crossing the extension direction of the first cover 111. Also, a plurality of plates 131 may be arranged in a line. However, an exemplary embodiment is not limited to the structure and shape of the plate 131.

The first hinge 132 may be fixed to the second cover 112 while connected to the plate 131 in a rotatable manner For example, the first hinge 132 may include a rotational shaft passing through the top side protruding portion of the plate 131 in a rotatable manner The rotational shaft may be coupled to the side surface of the second cover 112. Accordingly, the cover unit 110 may vertically rotate with respect to the first hinge 132. Accordingly, when the cover unit 110 rotates upwards, the opening of the chamber 200 may be opened, and when the cover unit 110 rotates downwards, the opening of the chamber 200 may be covered and closed by the cover unit 110. However, an exemplary embodiment is not limited to the structure of the first hinge 132.

The second hinge 133 may be fixed to the chamber 200 while connected to the plate 131 in a rotatable manner For example, the second hinge 133 may include a rotational shaft passing through the bottom side protruding portion of the plate 131 in a rotatable manner. The rotational shaft may be coupled to the side surface of the chamber 200. Accordingly, the plate 131 may vertically rotate with respect to the second hinge 133. Accordingly, when the plate 131 rotates, the cover unit 110 may rotate together with the plate 131. However, an exemplary embodiment is not limited to the structure of the second hinge 133.

As described above, the cover unit 110 and the chamber 200 may be connected by the hinge unit 130 having a dual hinge structure. Accordingly, since the cover unit 110 may doubly rotate by the hinge unit 130, interference between the cover unit 110 and the projection of the chamber 200, which occurs when the cover unit 110 is opened and closed, may be restrained or prevented. Thus, the cover unit 110 may be easily opened and closed, and a damage caused by collision between the cover unit 110 and the projection of the chamber 200 may be restrained or prevented. However, an exemplary embodiment is not limited to the structure of the hinge unit 130.

The first magnetic unit 120 may be installed on the cover unit 110 or the chamber 200. For example, the first magnetic unit 120 may be installed on a bottom surface of the first cover 111. The first magnetic unit 120 may include at least one of a metal member and a magnet (or permanent magnet), which contain a metal constituent. Accordingly, the first magnetic unit 120 may be coupled to or separated from the second magnetic unit 150 by a magnetic force.

Also, the first magnetic unit 120 may have a rectangular ring shape along the circumferential shape of the opening, or be provided in a type of a plurality of plates and arranged along the circumference of the opening. When the first magnetic unit 120 is a magnet, positions of polarity of the first magnetic unit 120, i.e., positions of N-pole and S-pole, are fixed. However, an exemplary embodiment is not limited to the structure, shape, and installation position of the first magnetic unit 120.

The second magnetic unit 150 may be installed on the chamber 200 or the cover unit 110 to face the first magnetic unit 120. That is, when the first magnetic unit 120 is installed on the cover unit 110, the second magnetic unit 150 may be installed on the chamber 200, and when the first magnetic unit 120 is installed on the chamber 200, the second magnetic unit 150 may be installed on the cover unit 110. For example, the second magnetic unit 150 may be installed on a top surface of the first projection 210 to face the first magnetic unit 120 and coupled to the first magnetic unit 120 by a magnetic force in a separable manner

Also, the second magnetic unit 150 may include a support member 151 installed on the chamber 200 or the cover unit 110 and a magnet member 152 installed in the support member 151 in a rotatable manner The second magnetic unit 150 may convert the positions of N-pole and S-pole. Accordingly, as the positions of polarities of the second magnetic unit 150 are converted, the second magnetic unit 150 may be coupled to or separated from the first magnetic unit 120.

Here, the first magnetic unit 120 and the second magnetic unit 150 may be provided in plurality and arranged along the circumference of the opening. When the circumference of the chamber 200 has a length greater than that of each of the first magnetic unit 120 and the second magnetic unit 150, the first magnetic unit 120 and the second magnetic unit 150 may be provided in plurality. In virtue of an attractive force between the first magnetic unit 120 and the second magnetic unit 150, although the first magnetic units 120 (or, second magnetic units 150) are spaced apart from each other, the cover unit 110 and the chamber 200 may closely contact each other and be sealed. Other members such as the hinge unit 130 may be disposed between the first magnetic units 120 (or, second magnetic units 150).

Also, the first magnetic unit 120 and the second magnetic unit 150 may not be disposed on a corner of the opening. Also, the first magnetic unit 120 and the second magnetic unit 150 may not be disposed on a position at which an extension direction is bent. Accordingly, since the magnet member 151 provided on the second magnet unit 150 may extend in one direction, the magnet member 151 may easily convert the position of polarity through rotation. However, an exemplary embodiment is not limited thereto. For example, the first magnetic unit 120 and the second magnetic unit 150 may be provided in singularity and arranged along the circumference of the opening.

The support member 151 serves to support the magnet member 152. For example, the support member 151 may be installed on the top surface of the first projection 210. The support member 151 may have a hollow-type inside, and the magnet member 152 may be inserted and rotate in the support member 151. The support member 151 is provided in singularity or plurality and arranged along the circumference of the opening.

When an attractive force is generated between the magnet member 151 and the first magnet unit 120 due to different polarities thereof, a top surface of the support member 151 and a bottom surface of the first magnet unit 120 may contact each other and be coupled by a magnetic force. However, an exemplary embodiment is not limited to the structure, shape, and installation position of the support member 151.

The magnet member 152 may be a permanent magnet having a magnetic force. The magnet member 152 may have a circular stick shape and be installed in the support member 151 in a rotatable manner That is, the magnet member 152 may convert positions of N-pole and S-pole through rotation. The magnet member 152 may be provided in plurality and arranged to surround the circumference of the opening. However, an exemplary embodiment is not limited to the structure and shape of the magnet member 152.

Also, a lever (not shown) may be installed on the magnet member 152 to rotate the magnet member 152. The lever may have a stick shape and rotate together with the magnet member 152. The lever may extend in a direction crossing the extension direction of the magnet member 152 and have one end connected to the magnet member 152 and the other end passing through the cover unit 110. Here, a through-hole (not shown) through which the lever passes may be defined in the cover unit 110. The through-hole defines a path through which the lever vertically rotates. Accordingly, when the other end of the lever vertically rotates with respect to one end thereof by the worker, the magnet member 152 may rotate, and the positions of polarity may be converted while the magnet member 152 rotates. Thus, the cover unit 110 and the chamber 200 may be coupled to or separated from each other.

Also, the magnet member 152 may be connected to a driving unit (not shown). The driving unit may be a motor or a rotary cylinder. The driving unit may be installed on the chamber 200 or the cover unit 110. The driving unit may be connected to a rotation central shaft of the magnet member 152. Accordingly, the magnet member 152 may rotate with respect to the central shaft by operation of the driving unit. Thus, the positions of S-pole and N-pole of the magnet member 152 may be converted. Here, the driving unit may be provided in singularity or plurality and connected to at least one of the magnet members 152 provided on the plurality of second magnet unit 150. The control unit 500 may control the operation of the driving unit to selectively open and close the opening of the chamber 200. However, an exemplary embodiment is not limited to the method for rotating the magnet member 152.

For example, when the first magnet unit 120 is a metal member, the magnet member 152 may rotate at an angle of approximately 80° to approximately 120°. For example, when the N-pole and S-pole of the magnet member 152 maintain a horizontal state, the magnet member 152 may be coupled to the first magnetic unit 120. Here, since the chamber 200 has an inner pressure greater than an external pressure, when the magnet member 152 rotates, a coupling force between the first magnetic unit 120 and the magnet member 152 may become weak, and the cover unit 110 may move upwards by the inner pressure of the chamber 200. Accordingly, the magnet member 152 may rotate to open the opening of the chamber 200.

Also, when the first magnetic unit 120 is a permanent magnet, as the first magnetic unit 120 is fixed, the positions of the polarities of the first magnetic unit 120 are not converted. The second magnetic unit 150 may rotate at an angle equal to or greater than approximately 180°. Accordingly, when the polarity of the top surface of the second magnetic unit is different from that of the bottom surface of the first magnetic unit 120 by rotating the second magnetic unit 150, the first magnetic unit 120 is attached to the second magnetic unit 150 by the magnetic force between the first magnetic unit 120 and the second magnetic unit 150. Thus, the cover unit 110 may cover the opening of the chamber 200, and the inside of the chamber 200 may be sealed.

On the contrary, when the portions, which face each other, of the first magnetic unit 120 and the second magnetic unit 150 have the same polarity by rotating the second magnetic unit 150, the first magnetic unit 120 and the second magnetic unit 150 may push each other. Accordingly, the cover unit 110 may move upwards, and the opening of the chamber 200 may be opened. Thus, the opening of the chamber 200 may be opened and closed by rotating the second magnetic unit 150.

The buffer unit (not shown) may be installed on at least one of the first magnetic unit 120 and the second magnetic unit 150 to reduce an impact between the first magnetic unit 120 and the second magnetic unit 150. The buffer unit may protrude downwards further than the first magnetic unit 120 or protrude upwards further than the second magnetic unit 150. The buffer unit may surround the circumference of the first magnetic unit 120 or the second magnetic unit 150. For example, when the buffer unit surrounds the circumference of the first magnetic unit 120, the buffer unit may protrude downwards further than the first magnetic unit 120 and have an elastic force for contraction or extension.

Here, when the portions, which face each other, of the first magnetic unit 120 and the second magnetic unit 150 have different polarities to attract each other, the buffer unit is compressed by firstly contacting the top surface of the first projection 210 or the top surface of the second magnetic unit 150, and then, the first magnetic unit 120 and the second magnetic unit 150 may contact each other. Accordingly, as the buffer unit is compressed, the impact generated by contact between the first magnetic unit 120 and the second magnetic unit 150 may be restrained or prevented. However, an exemplary embodiment is not limited to the structure, shape, and installation position of the buffer unit.

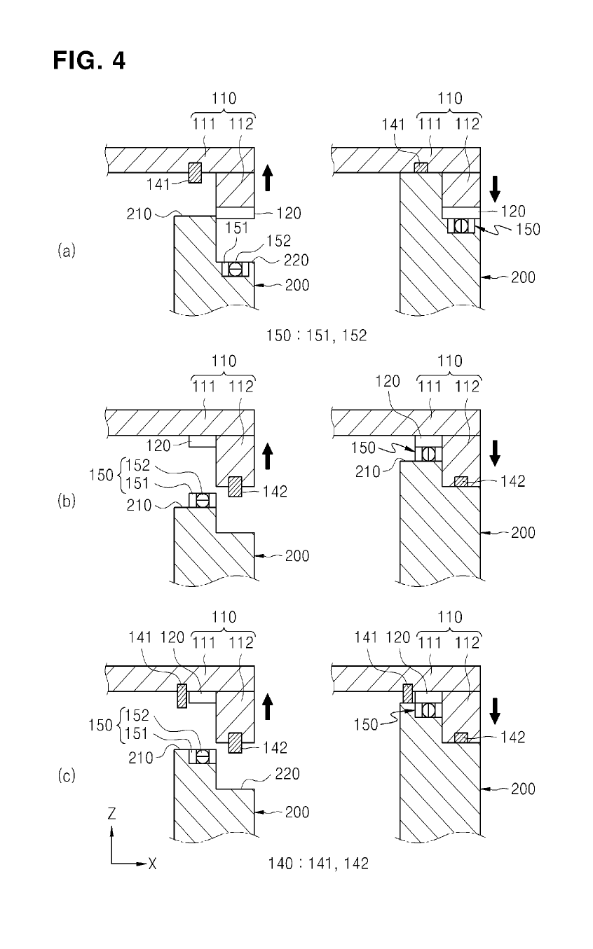

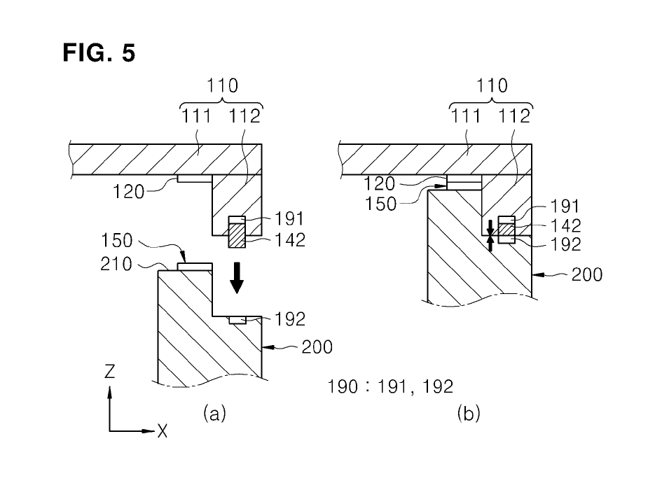

FIG. 4 is a view illustrating a structure of a door apparatus in accordance with an exemplary embodiment, and FIG. 5 is a view illustrating an operational structure of a pressing unit in accordance with an exemplary embodiment. Hereinafter, a sealing unit and a pressing unit in accordance with an exemplary embodiment will be described.

Referring to FIG. 4, a sealing unit 140 serves to block a gap between the chamber 200 and the cover unit 110. The sealing unit 140 may be formed along the circumference of the opening and disposed on at least one of the inside and outside of the circumference of each of the first magnetic unit 120 and the second magnetic unit 150.

Also, the sealing unit 140 may be installed on the cover unit 110 and have at least one portion protruding outside the cover unit 110. Here, since the sealing unit 140 has an elastic force, the sealing unit 140 may be extended or contracted. Accordingly, the sealing unit 140 may firstly contact the chamber 200 before the cover unit 110 contacts the same when the cover unit 110 is closed, and the cover unit 110 may contact the chamber 200 while the sealing unit 140 is contracted. Accordingly, the sealing unit 140 may reduce the impact between the cover unit 110 and the chamber 200 and effectively block the gap between the cover unit 110 and the chamber 200. The sealing unit 140 may include at least one of a first sealing member 141 installed on the first cover 111 and a second sealing member 142 installed on the second cover 112.

As illustrated in (a) of FIG. 4, when only the first sealing member 141 is provided, the first sealing member 141 may be installed on a portion, which faces the first projection 210, of the first cover 111 and contact the top surface of the first projection 210. For example, a groove into which at least a portion of the first cover 111 is inserted may be defined in a lower portion of the first sealing member 141, and the first sealing member 141 may be inserted into a groove defined in the first cover 111. The first sealing member 141 may serve as an O-ring and block a gap between the first cover 111 and the first projection 210.

Also, the first sealing member 141 may protrude downwards further than the bottom surface of the first cover 111 and have an elastic force. Here, when the first magnetic unit 120 is installed on the lower portion of the first cover 111, the first sealing member 141 may protrude downwards further than the bottom surface of the first magnetic unit 120. Accordingly, when the first cover 111 closely contact the first projection 210, the first sealing member 141 may be compressed between the first cover 111 and the first projection 210. Thus, the first cover 111 may contact the first projection 210. Also, the first magnetic unit 120 may contact the second magnetic unit 150 installed on the first projection 210. The first sealing member 141 may block all of the gaps between the first cover 111 and the first projection 210 to seal the inside of the chamber 200. However, an exemplary embodiment is not limited to the structure and position of the first sealing member 141.

As illustrated in (b) of FIG. 4, when only the second sealing member 142 is provided, the second sealing member 142 may be installed on a portion, which faces the second projection 220, of the second cover 112 and contact the top surface of the second projection 220. For example, a groove into which at least a portion of the second cover 112 is inserted may be defined in a lower portion of the second sealing member 142, and the second sealing member 142 may be inserted into a groove defined in the second cover 112. The second sealing member 142 may serve as an O-ring and block a gap between the second cover 112 and the second projection 220.

Also, the second sealing member 142 may protrude downwards further than the bottom surface of the second cover 112 and have an elastic force. Accordingly, when the second cover 112 closely contact the second projection 220, the second sealing member 142 may be compressed between the second cover 112 and the second projection 220. Thus, the second cover 112 may contact the second projection 220, and the second sealing member 142 may block all the gap between the second cover 112 and the second projection 220, so that the inside of the chamber 200 is sealed. However, an exemplary embodiment is not limited to the structure and position of the second sealing member 142.

As illustrated in (c) of FIG. 4, all of the first sealing member 141 and the second sealing member 142 may be provided. Accordingly, the gap between the first cover 111 and the first projection 210 may be primary-blocked by the first sealing member 141, and the gap between the second cover 112 and the second projection 220 may be secondary-blocked by the second sealing member 142. That is, since the inside of the chamber 200 is sealed in a double manner, the chamber 200 may effectively prevent an external gas from being introduced into the chamber 200 or an inner gas of the chamber 200 from being leaked to the outside. However, an exemplary embodiment is not limited to the structure and component of the cover unit 110.

As illustrated in FIG. 5, the pressing unit 190 serves to press the sealing unit 140 so that the sealing unit 140 closely contacts the chamber 200. The pressing unit 190 may include a first magnetic body 191 installed on the cover unit 110 and a second magnetic body 192 installed on the chamber 200.

The first magnetic body 191 may be installed on the cover unit 110. For example, the first magnetic body 191 may be installed into the groove into which the first sealing member 141 of the cover unit 110 is inserted. The first magnetic body 191 may be a magnet or an electromagnet having a magnetic force. Also, when the second magnetic body 192 is made of a material having a magnetic force, the first magnetic body 191 may be made of metal having an attachment property of a magnet.

The second magnetic body 192 may be installed on the chamber 200. The second magnetic body 192 may face the sealing unit 140. Accordingly, when the cover unit 110 is closed, the sealing unit 140 may be disposed between the first magnetic body 191 and the second magnetic body 192. That is, the first magnetic body 191, the sealing unit 140, and the second magnetic body 192 may be disposed on the same line in a vertical direction. The second magnetic body 192 may be a magnet or an electromagnet having a magnetic force. Also, when the first magnetic body 191 is made of a material having a magnetic force, the second magnetic body 192 may be made of metal having an attachment property of a magnet.

When the cover unit 110 is closed, and the first magnetic body 191 and the second magnetic body 192 become adjacent to each other, the first magnetic body 191 and the second magnetic body 192 may attract each other by a magnetic force. Accordingly, the sealing unit 140 may be compressed between the first magnetic body 191 and the second magnetic body 192, and the cover unit 110 may be stably closed onto the chamber 200. Also, as the sealing unit 140 is compressed, the first magnetic unit 120 and the second magnetic unit 150 may be stably attached to each other.

Here, since the first magnetic body 191 and the second magnetic body 192 are spaced apart from each other, a force generated between the first magnetic body 191 and the second magnetic body 192 may be less than that generated between the first magnetic unit 120 and the second magnetic unit 150. Thus, when a repulsive force is generated between the first magnetic unit 120 and the second magnetic unit 150, the cover unit 110 may stably open the opening of the chamber 200. However, an exemplary embodiment is not limited to the method of pressing the sealing unit 140 by the pressing unit 190.

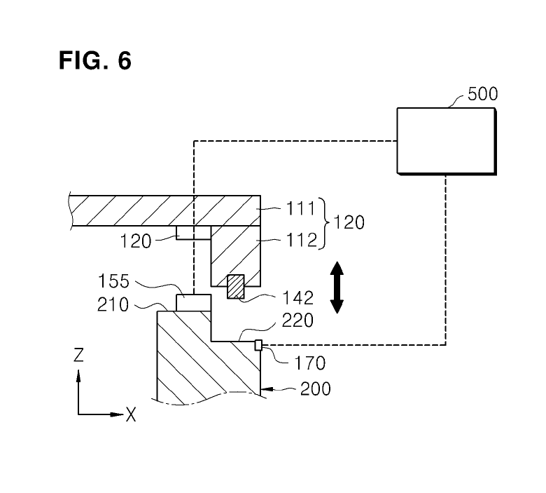

FIG. 6 is a view illustrating a structure of a door apparatus in accordance with an exemplary embodiment. Hereinafter, a structure of the second magnetic unit 150 in accordance with another exemplary embodiment will be described.

Referring to FIG. 6, the second magnetic unit 150 in accordance with another exemplary embodiment may include an electromagnet 155 and a power supply unit (not shown) providing a power to the electromagnet 155.

The electromagnet 155 may generate a magnetic force when a power is supplied. Also, the electromagnet 155 may have polarity that is converted on the basis of a direction of a supplied power. The electromagnet 155 may be provided in singularity or plurality and installed along the circumference of the opening. For example, the electromagnet 155 may be installed on the top surface of the first projection 210, and the top surface may face the first magnetic unit 120 installed on the bottom surface of the first cover 11. However, an exemplary embodiment is not limited to the installation position of the electromagnet 155.

The power supply unit is connected to the electromagnet 155 and serves to supply a power to the electromagnet 155. Accordingly, when the power supply unit provides a power to the electromagnet 155, the electromagnet 155 may have a magnetic force, and when the power supply unit stops to provide a power, the electromagnet 155 may lose the magnetic force. That is, the power supply unit serves as a switch of the electromagnet 155. Accordingly, when the cover unit 110 closes the chamber 200, a power may be supplied to the electromagnet 155, and when the chamber 200 is opened, the power supply to the electromagnet 155 may be stopped. Also, the power supply unit may change a direction of current supply to convert positions of polarity of the electromagnet 155.

Meanwhile, the first magnet unit 120 may be a magnet. For example, a surface, which faces the electromagnet 155, of the first magnet unit 120 may be N-pole. Here, when the electromagnet 155 is converted in polarity, and thus, the electromagnet 155 has a polarity different from that of the first magnetic unit 120, the electromagnet 155 may be attached to the first magnetic unit 120, and the inside of the chamber 200 may be sealed. On the contrary, when the electromagnet 155 is converted in polarity, and thus, the electromagnet 155 has the same polarity as that of the first magnetic unit 120, the electromagnet 155 may be easily separated from the first magnetic unit 120 because the electromagnet 155 and the surface, which faces the electromagnet 155, of the first magnetic unit 120 have the same polarity.

Also, the first magnetic unit 120 may be a metal member. Accordingly, when the cover unit 110 is coupled to the chamber 200, the power supply unit may supply a current to the electromagnet 155, so that the electromagnet 155 has a magnetic force. On the contrary, when the cover unit 110 is separated from the chamber 200, the power supply unit may stop to supply a current to the electromagnet 155, so that the electromagnet 155 loses a magnetic force. Accordingly, the cover unit 110 may easily open and close the opening of the chamber 200.

Also, the first magnetic unit 120 may be an electromagnet. Accordingly, when the inside of the chamber 200 is sealed, as the first magnetic unit 120 and the electromagnet 155 has the different polarities, the cover unit 110 may be coupled to the chamber 200. When the inside of the chamber is opened, the first magnetic unit 120 and the electromagnet 155 have the same polarity, the cover unit 110 may be separated from the chamber 200. Thus, as the first magnetic unit 120 and the electromagnet 155 are converted in polarity, the inside of the chamber may be automatically opened and closed.

However, an exemplary embodiment is not limited to the position of polarity of the first magnetic unit 120 and the installation position of the electromagnet. Also, when the electromagnet 155 is installed on the first cover 111, the first magnetic unit 120 may be installed on a portion, which contacts the second magnetic unit 150, of the first projection 210. Also, a buffer unit 122b, which will be described later, may be installed on at least a portion of the circumference of the magnet member 152 or the electromagnet 155. Accordingly, an impact generated when the cover unit 110 contacts the chamber 200 may be restrained or prevented by a magnetic force. Meanwhile, the second magnetic unit 150 may be installed on the second cover 112 or the second projection 220.

The position detecting unit 170 serves to detect a position of the cover unit 110. For example, the position detecting unit 170 may be a contact sensor and installed on the bottom surface of the cover unit 110 to contact the top surface of the chamber 200. Also, the position detecting unit 170 may be installed on the top surface of the chamber 200 to contact the bottom surface of the cover unit 110. Accordingly, when the cover unit 110 or the chamber 200 contacts the position detecting unit 170, the position detecting unit 170 may detect that the cover unit 110 covers the opening of the chamber 200. On the other hand, when the cover unit 110 or the chamber 200 is not in contact with the position detecting unit 170, the position detecting unit 170 may detect that the cover unit 110 does not cover the opening of the chamber 200. However, an exemplary embodiment is not limited to the method of detection the position of the cover unit 110 by the position detecting unit 170.

Here, the control unit 500 may be connected to the position detecting unit 170 and control operation of the second magnetic unit 150. That is, the control unit 500 may control the operation of the second magnetic unit 150 according to the position of the cover unit 110 to allow the cover unit 110 to closely contact to or separated from the chamber 200. For example, when the worker allows the cover unit 110 to rotate downwards, so that the cover unit 110 contacts the chamber 200, the control unit 500 may supply a power to the electromagnet 155. Accordingly, a state in which the cover unit 110 automatically closely contacts the chamber 200 may be maintained.

On the contrary, when the worker allows the cover unit 110 to rotate upwards, so that the cover unit 110 is separated from the chamber 200, the control unit 160 may be converted in positions of N-pole and S-pole to stop the power supply. Accordingly, a state in which the cover unit 110 opens the opening of the chamber 200 may be maintained.

Meanwhile, the control unit 500 may also detect that the worker opens and closes the cover unit 110. For example, the controller may detect a force of the worker, which is applied to the cover unit 110. Accordingly, when the force of the worker is applied to the handle, the control unit 500 may convert the positions of N-pole and S-pole of the electromagnet or stop to supply a power. Thus, the worker may easily open the cover unit 110.

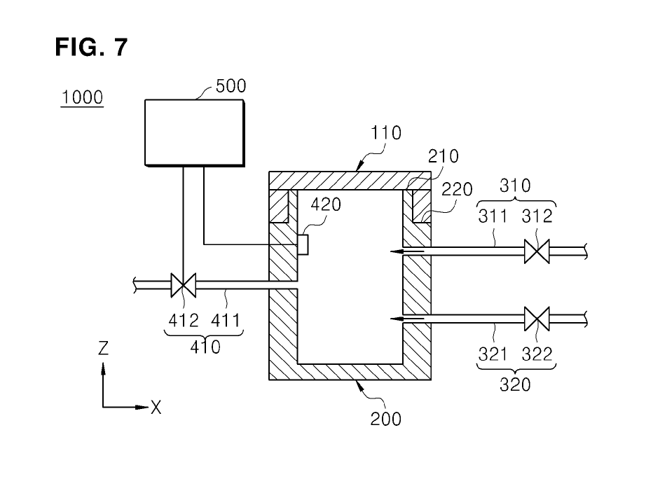

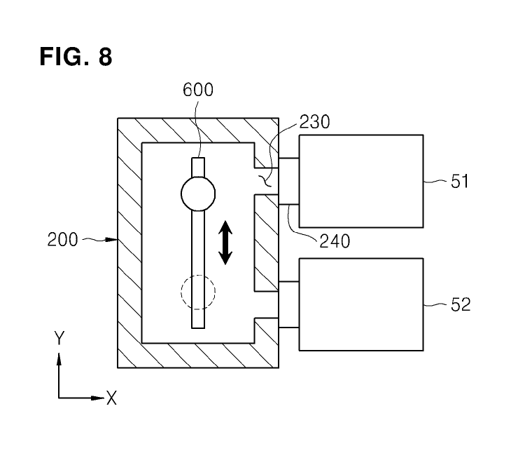

FIG. 7 is a view illustrating a structure of a glove box in accordance with an exemplary embodiment. FIG. 8 is a plane view illustrating a structure of a glove box in accordance with an exemplary embodiment. Hereinafter, a gas discharge unit, an oxygen measuring unit, and a control unit in accordance with an exemplary embodiment will be described.

Referring to FIG. 8, a gas supply unit 310 serves to supply an inert gas (e.g., N₂ gas) into the chamber 200. Accordingly, gas atmospheres inside and outside the chamber 200 may be different. The gas supply unit 310 may include a supply line 311 and a supply valve 312.

The supply line 311 may define a path through which the inert gas moves. The supply line 311 has one end connected to a tank (not shown) in which the inert gas is stored and the other end connected to the upper portion of the chamber 200. Accordingly, the inert gas stored in the tank may be supplied into the chamber 200 through the supply line 311. Thus, the inside of the chamber 200 may be filled with the inert gas.

The supply valve 312 is installed on the supply line 311. The supply valve 312 serves to open and close the moving path of the inert gas, which is defined in the supply line 311. Accordingly, the supply valve 312 may be controlled in operation to adjust an amount of inert gas supplied to the chamber 200. However, an exemplary embodiment is not limited to the structure of the gas supply unit 310.

The gas discharge unit 320 serves to discharge a gas in the chamber 200 to the outside. Accordingly, air in the chamber 200 may be removed, and the inside of the chamber 200 may be filled with only the inert gas. Also, the inert gas in the chamber 200 may be removed. The gas discharge unit 320 may include a discharge line 321 and a discharge valve 322.

The discharge line 321 may define a path through which a gas moves. The discharge line 321 has one end connected to a discharge pump (not shown) and the other end connected to the lower portion of the chamber 200. Accordingly, the inert gas or air in the chamber 200 may be discharged out of the chamber 200 through the discharge line 321.

The discharge valve 322 is installed on the discharge line 321. The discharge valve 322 serves to open and close the moving path of the gas, which is defined in the discharge line 321. Accordingly, the discharge valve 322 may be controlled in operation to selectively remove the gas in the chamber 200. However, an exemplary embodiment is not limited to the structure of the gas discharge unit 320.

The transfer unit 600 is installed in the inner space of the chamber 200. For example, the transfer unit 600 may be a transfer robot for transferring a substrate. Accordingly, the transfer unit 600 may transfer a substrate through an inlet-outlet port 230 defined in the chamber 200. For example, a substrate transferred from one device 51 for processing a substrate may be inserted into the chamber 200 by the transfer unit 600, and the transfer unit 600 may transfer the substrate to another device 52 for processing a substrate, which is communicated with the chamber 200. Since the chamber 200 is filled with the inert gas, the substrate may be prevented from being contaminated while transferred. Here, a gate 240 provided on the chamber 200 may be operated together with the transfer unit 600 to transfer the substrate. However, a device for performing another process may be installed in the chamber 200 instead of the transfer unit 600.

The oxygen measuring unit 420 may be installed in the chamber 200. The oxygen measuring unit 420 may be a sensor for measuring an oxygen concentration. Accordingly the oxygen concentration in the chamber 200 may be monitored by the oxygen measuring unit 420.

The oxygen supply unit 410 serves to supply a gas containing oxygen into the chamber 200.

Accordingly, the oxygen concentration in the chamber 200 may increase. The oxygen supply unit 410 may include an oxygen line 411 and a control valve 412.

The oxygen line 411 may define a path through which a gas containing oxygen moves. The oxygen line 411 has one end connected to an oxygen tank (not shown) in which the gas containing oxygen is stored and the other end connected to the chamber 200. Accordingly, the gas stored in the oxygen tank may be supplied into the chamber 200 through the oxygen line 411. Thus, the chamber 200 may be filled with the gas containing oxygen.

The control valve 412 is installed on the oxygen line 411. The control valve 412 serves to open and close the moving path of the gas containing oxygen, which is defined in the oxygen line 411. Accordingly, the control valve 412 may be controlled in operation to adjust an amount of the gas containing oxygen supplied to the chamber 200. However, an exemplary embodiment is not limited to the structure of the oxygen supply unit 410.

The control unit 500 may convert the polarity of the second magnetic unit according to a measurement result of the oxygen measuring unit 420. When an oxygen concentration in the chamber 200 is less than approximately 20%, if the worker opens the inside of the chamber 200, the worker may be suffocated. Accordingly, when the worker controls the operation of the door apparatus 100 to open the inside of the chamber 200, the control unit 500 may selectively open the door apparatus 100 according to the oxygen concentration in the chamber 200.

For example, the control unit 500 may compare a measurement value that is measured by the oxygen measuring unit 420 and a concentration value that is pre-set. Accordingly, when the measurement value is less than the pre-set concentration value, the door apparatus 100 may be controlled not to be opened by the worker. When the measurement value is equal to or greater than the pre-set concentration value, the control unit 500 may control the door apparatus 100 to be opened by the worker.

Also, the control unit 500 may control the operation of the oxygen supply unit 410. That is, when the worker opens the door apparatus 100 in a state in which the measurement value is less than the pre-set concentration value, the control unit 500 may control the operation of the oxygen supply unit 410 to supply the gas containing oxygen into the chamber 200. Accordingly, when the worker opens the door apparatus 100 in a state in which the oxygen concentration increases in the chamber 200, the worker may be prevented from being suffocated. Meanwhile, when equipment in the chamber 200 is damaged, the chamber 200 may be opened to perform a repair or maintenance work. Besides the above case, the inside of the chamber 200 may be sealed.

As described above, the second magnetic unit 150 capable of converting the positions of polarity is provided on the chamber 200 or the cover unit 100 that opens and closes the opening of the chamber 200. Accordingly, as the polarity of the second magnetic unit 150 is converted, the chamber 200 and the cover unit 110 may be coupled to or separated from each other. Accordingly, the opening of the chamber 200 may be opened and closed in an easy and fast manner by controlling the operation of the second magnetic unit 150.

Also, as the chamber 200 and the cover unit 110 closely contact each other by the magnetic force of the second magnetic unit 150, the gap between the chamber 200 and the cover unit 110 may be sealed. Accordingly, the gas in the chamber 200 may be prevented from being leaked to the outside, or the external gas out of the chamber 200 may be prevented from being introduced into the chamber 200.

Also, an impact applied to the cover unit 110 may be reduced further than that applied when a clamp unit is used. Thus, the cover unit 110 may increase in lifespan, and maintenance for equipment may be easily performed.

In accordance with the exemplary embodiments, the magnetic unit capable of converting the direction of the polarity is provided on the chamber or the cover unit that opens and closes the opening of the chamber. Accordingly, the chamber and the cover unit may be coupled to or separated from each other by converting the polarity of the magnetic unit. Thus, the opening of the box may be opened and closed in an easy and fast manner by controlling the operation of the magnetic unit.

Also, as the chamber and the cover unit closely contact each other by the magnetic force of the magnetic unit, the gap between the chamber and the cover unit may be blocked. Accordingly, the gas in the chamber may be prevented from being leaked to the outside, or the external gas out of the chamber may be prevented from being introduced into the chamber.

Also, the impact applied to the cover unit may be reduced further than that applied when the clamp unit is used. Thus, the cover unit may increase in lifespan, and the maintenance of equipment may be easily performed.

As described above, while this invention has been particularly shown and described with reference to preferred embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A door apparatus that is installed on a chamber comprising an inner space and an opening defined in one surface thereof, comprising:
a cover unit configured to cover the opening;
a first magnetic unit installed on the cover unit or the chamber; and
a second magnetic unit installed on the cover unit or the chamber to face the first magnetic unit, converting a polarity thereof, and coupled to the first magnetic unit in a separable manner

2. The door apparatus of claim 1, wherein the first magnetic unit is fixed, and the second magnetic unit is converted in position of a polarity.

3. The door apparatus of claim 2, wherein the second magnetic unit comprises a support member installed on the chamber or the cover unit and a magnet member installed in the support member in a rotatable manner

4. The door apparatus of claim 1, wherein the second magnetic unit comprises an electromagnet and a power supply unit configured to supply a current to the electromagnet.

5. The door apparatus of claim 4, further comprising:
a position detecting unit configured to detect a position of the cover unit; and
a control unit connected to the position detecting unit and control an operation of the power supply unit.

6. The door apparatus of claim 1, wherein the first magnetic unit comprises at least one of a metal member and a magnet.

7. The door apparatus of claim 1, further comprising a buffer unit installed on at least one of the first magnetic unit and the second magnetic unit in order to reduce an impact between the first magnetic unit and the second magnetic unit.

8. The door apparatus of claim 1, wherein the chamber comprises a first projection configured to surround a circumference of the opening and a second projection configured to surround a circumference of the first projection, and
the cover unit comprises a first cover configured to cover the opening and a second cover connected to the first cover to cover a gap between the first cover and the first projection and contacting the second projection.

9. The door apparatus of claim 8, further comprising a sealing unit installed on the cover unit in order to block a gap between the chamber and the cover unit and contacting the chamber.

10. The door apparatus of claim 9, wherein the sealing unit comprises at least one of a first sealing member installed on the first cover and a second sealing member installed on the second cover.

11. A glove box comprising:
a chamber having an inner space and an opening defined in one surface thereof;
a gas supply unit configured to supply an inert gas into the chamber; and
a door configured to open and close the opening by a magnetic force.

12. The glove box of claim 11, wherein the door comprises:
a cover unit configured to cover the opening;
a first magnetic unit installed on the cover unit or the chamber; and
a second magnetic unit installed on the chamber or the cover unit to face the first magnetic unit and converting a polarity of a portion facing the first magnetic unit.

13. The glove box of claim 12, wherein the first magnetic unit and the second magnetic unit are provided in plurality and arranged along a circumference of the opening.

14. The glove box of claim 12, wherein the door further comprises a sealing unit installed on the cover unit so as to contact the chamber and arranged at least one position of an inside and an outside of a circumference of each of the first magnetic unit and the second magnetic unit along the circumference of the opening.

15. The glove box of claim 14, wherein the sealing unit has at least one portion protruding the outside of the cover unit, and
the door further comprises a pressing unit configured to allow the sealing unit to closely contact the chamber.

16. The glove box of claim 15, wherein the pressing unit comprises a first magnetic body installed on the cover unit and a second magnetic body installed on the chamber, and
the sealing unit is disposed between the first magnetic body and the second magnetic body.

17. The glove box of claim 11, further comprising:
an oxygen measuring unit configured to measure an oxygen concentration in the chamber; and
a control unit configured to convert a polarity of the second magnetic unit on the basis of a measurement result obtained by the oxygen measuring unit.

18. The glove box of claim 17, further comprising an oxygen supply unit configured to supply a gas containing oxygen into the chamber.

19. The glove box of claim 11, further comprising:
an inlet-outlet port defined in the chamber;
a gate configured to open and close the inlet-outlet port; and
a transfer unit installed in the chamber to transfer a substrate through the inlet-outlet port.
